(19) United States
(12) Patent Application Publication
(10) Pub. No.: US 2024/0305646 A1
(43) Pub. Date: Sep. 12, 2024

(54) CREDIT UNITS-BASED ACCESS CONTROL FOR DATA CENTER RESOURCES

(71) Applicant: VMWARE, INC., Palo Alto, CA (US)

(72) Inventors: NAREN LAL, Bangalore (IN); Ranganathan Srinivasan, Bangalore (IN); Nidhin Urmese, Bangalroe (IN); Akshay Anand, Bangalore (IN); Saritha H, Bangalore (IN)

(21) Appl. No.: 18/119,862

(22) Filed: Mar. 10, 2023

(51) Int. Cl. H04L 9/40; G06F 9/455

(52) U.S. Cl. CPC H04L 63/105; G06F 9/45558; H04L 63/102; H04L 63/104; G06F 2009/45595

(57) ABSTRACT

An example method may include generating a credit unit defining a value indicating a number of times an operation can be performed on a resource type in a data center. Further, the method may include assigning credits, a credit limit, and the credit unit to a user account. The credit limit may indicate maximum credits that can be used to perform each operation. Furthermore, the method may include receiving a request to perform an operation on a data center resource from a user associated with the user account. Upon receiving the request, the method may include determining whether the user is permitted to perform the operation on the data center resource based on available credits of the assigned credits, the credit limit, and the credit unit. Further, the method may include executing or denying execution of the operation on the data center resource based on the determination.

### TECHNICAL FIELD

The present disclosure relates to computing environments, and more particularly to methods, techniques, and systems for controlling access to perform operations on data center resources based on credit units.

### BACKGROUND

A data center is a facility that houses a wide range of hardware components such as servers, storage devices, communication equipment, and the like, organized into clusters. For example, an information technology (IT) service provider may maintain a data center. An enterprise may purchase data storage and/or data processing services from the provider in order to run applications that manage the enterprises' core business and operational data. The applications may be proprietary and used exclusively by the enterprise or made available through a network for anyone to access and use.

Virtual computing instances (VCIs), such as virtual machines (VMs), virtual workloads, data compute nodes, clusters, containers, and the like, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of the enterprise without affecting the use of the enterprise's applications. VCIs can be deployed on a hypervisor provisioned with a pool of computing resources (e.g., processing resources, memory resources, and the like). Multiple VCIs can be configured to be in communication with each other in a distributed computing system (e.g., a data center). Such a data center can include various resources/objects such as a server resource, a storage resource, a network resource, a virtual resource, and/or the like.

### BRIEF DESCRIPTION OF THE DRAWINGS

FIG. 1 is a block diagram of an example computing environment, including a management node to control an access to perform a requested operation on a data center resource;

FIG. 2A is an example graphical user interface depicting generation of a credit unit;

FIG. 2B is an example graphical user interface depicting assignment of credit units to a user account;

FIG. 2C is an example graphical user interface depicting assignment of credits and a credit limit to a user account;

FIG. 2D is an example graphical user interface depicting associating the value to each type of operation on the data center resource;

FIG. 2E is an example graphical user interface depicting execution of an operation on the data center resource;

FIG. 2F is an example graphical user interface depicting a notification indicating status of the execution of the operation on the data center resource;

FIG. 3 is a flowchart illustrating an example method for controlling an access to perform a requested operation on a data center resource;

FIG. 4 is a flowchart illustrating another example method for controlling an access to perform a requested operation on a data center resource;

FIG. 5A is an example graphical user interface depicting associating active credits corresponding to a user account;

FIG. 5B is an example graphical user interface depicting associating passive credits corresponding to a user account;

FIG. 6A is a flowchart illustrating an example method for deducting credits when the credits are defined as active credits;

FIG. 6B is a flowchart illustrating an example method for deducting credits when the credits are defined as passive credits; and

FIG. 7 is a block diagram of an example computing device including non-transitory computer-readable storage medium storing instructions to execute a requested operation on a data center resource.

The drawings described herein are for illustration purposes only and are not intended to limit the scope of the present subject matter in any way.

### DETAILED DESCRIPTION

The term “virtual computing instance (VCI)” may cover a range of computing functionality. VCIs may include non-virtualized physical hosts, virtual machines (VMs), and/or containers. Containers can run on a host operating system without a hypervisor or separate operating system, such as a container that runs within Linux. A container can be provided by a VM that includes a container virtualization layer (e.g., Docker). A VM may refer to an isolated user space instance, which can be executed within a virtualized environment. Other technologies aside from hardware virtualization can provide isolated user space instances, also referred to as VCIs. The term “VCI” covers these examples and combinations of different types of VCIs, among others.

The VMs, in some examples, may operate with their own guest operating systems on a host using resources of the host virtualized by virtualization software (e.g., a hypervisor, VM monitor, and the like). The tenant (i.e., the owner of the VM) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VM segregation that may be offered in hypervisor-virtualized environments that virtualize system hardware, and thus can be viewed as a form of virtualization that isolates different groups of applications that operate in different containers.

Multiple VCIs can be configured to be in communication with each other in a distributed computing system (e.g., a software defined data center). Software defined data centers are dynamic in nature. For example, VCIs and/or various application services, may be created, used, moved, or destroyed within the software defined data center. When VCIs are created (e.g., when a container is initialized), various processes and/or services start running and consuming data center resources. As used herein, “data center resources” are physical or virtual components that have a finite availability within a computer or software defined data center. For example, resources include processing resources, memory resources, electrical power, input/output resources, and/or the like.

An example data center resource can be a server resource, a storage resource, a network resource, or a virtual resource in the data center. For example, data center resources may include VMs, host computing devices, clusters or workload domains, port groups, resource pools, VM containers for multiple VMs (e.g., vAPP), virtual infrastructure resource management components (e.g., VCD), and/or other VM objects. In some examples, the data center resources can include a combination of software and hardware (e.g., a pool of computing resources) or include hardware configured to perform operations, and control or otherwise manipulate the infrastructure of a distributed computing system (e.g., a cloud environment, a virtualized environment, or the like).

Further, such data centers can be monitored/managed by one or more administrators or an authorized person of an organization/enterprise. For example, an administrator may assign rights to users or other administrators to control access to the data center resources (e.g., to perform one or more operations on the data center resources). In some examples, a role-based access control, which provides access based on permissions, may be used to control the access to the data center resources. For example, a user with a manager role is permitted to access certain data center resources and a user with team lead role is permitted to access different data center resources. In other examples, a scope-based access control, which provides access on resources in a specified range, may be used to control the access to the data center resources. For example, assigning scope 1 to the user may result in only accessing the resources in scope 1.

Furthermore, consider a scenario where the administrator may have to assign a user with an administrator role (e.g., having access to all data center resources) but would want to restrict a set of operations on a critical data center resource. For example, the administrator may assign a user with administrator role but restrict the user from deleting a host (i.e., the data center resource). In order to restrict the set of operations on the data center resource, multiple roles and scopes may have to be assigned to the user. Creating and assigning multiple roles may be a complex and cumbersome process. Also, maintaining a significant number of roles created or available out of box can be complex.

Examples described herein may provide a management node to control an access to perform an operation on a data center resource. The management node may assign credits to a user account and also set a credit limit corresponding to the user account. The credit limit may indicate maximum credits that can be used to perform each operation in a data center. Further, the management node may assign a credit unit to the user account. The credit unit may include a value indicating a number of times an operation can be performed on a resource type.

During operation, the management node may receive a request to perform an operation on a data center resource from a user associated with the user account. In response to receiving the request, the management node may determine whether the user is permitted to perform the requested operation on the data center resource based on available credits of the assigned credits, the credit limit, and the credit unit. Based on the determination, the management node may execute or deny execution of the requested operation on the data center resource.

Thus, examples described herein may restrict access to critical data center resources to a number of operations. Further, examples described herein may provide a fine-grained credit-based access control at an operation level on a data center resource and is dynamically configurable. With credit units-based access, the administrator can control access provision at finer operation levels on the data center resources to provide enhanced security to the data center resources.

In the following description, for purposes of explanation, numerous specific details are set forth in order to provide a thorough understanding of the present techniques. It will be apparent, however, to one skilled in the art that the present apparatus, devices, and systems may be practiced without these specific details. Reference in the specification to “an example” or similar language means that a particular feature, structure, or characteristic described is included in at least that one example, but not necessarily in other examples.

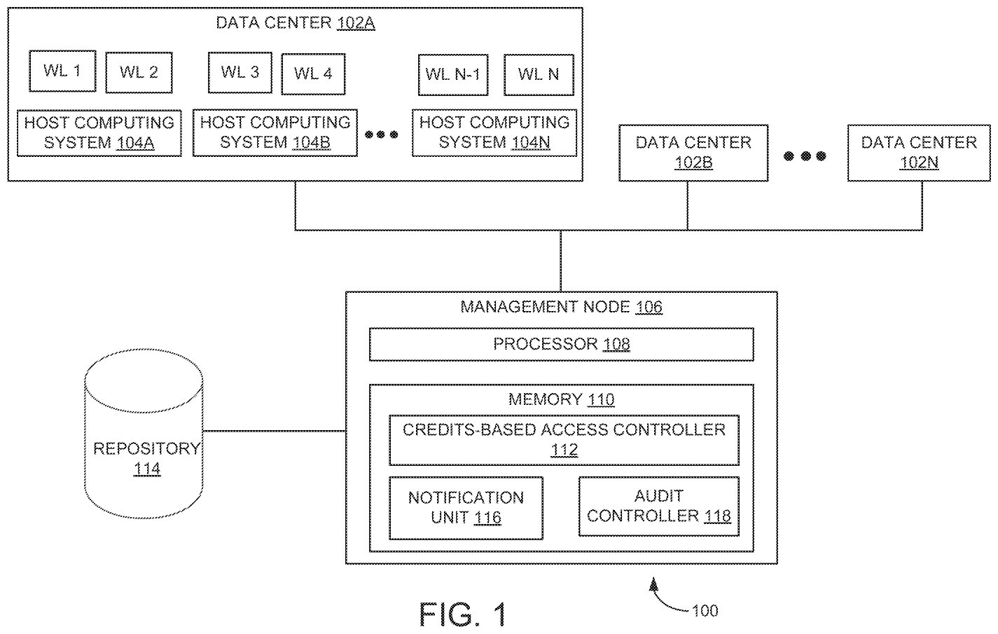

FIG. 1 is a block diagram of an example computing environment 100, including a management node 106 to control an access to perform a requested operation on a data center resource. Example computing environment 100 may include multiple data centers 102A to 102N. A data center may be a physical data center (e.g., an on-premise enterprise computing environment) and/or virtual data center (e.g., a cloud computing environment, a virtualized environment, or the like). The virtual data center may be a pool or collection of cloud infrastructure resources designed for enterprise needs. Further, the virtual data center may be a virtual representation of a physical data center, complete with servers, storage clusters, and networking components, all of which may reside in virtual space being hosted by one or more physical data centers.

As shown in FIG. 1, each data center (e.g., 102A) may include multiple application hosts (e.g., host computing systems 104A to 104N) executing a plurality of applications. Example application host may be a physical computer (e.g., 104A to 104N), a workload (e.g., WL1 to WLN such as a VM, a container, or the like) running on the physical computer, and/or the like. The physical computer may be a hardware-based device (e.g., a personal computer, a laptop, or the like) including an operating system (OS) and executing applications. The VM may operate with its own guest OS on the physical computer using resources of the physical computer virtualized by virtualization software (e.g., a hypervisor, a VM monitor, and the like). The container may be a data computer node that runs on top of a host OS without the need for a hypervisor or separate OS. In some examples, each host computing system 104A to 104N may run a hypervisor that creates and runs VMs.

Further, computing environment 100 may include management node 106 communicatively connected to data centers 102A to 102N via a network. Example network can be a managed Internet protocol (IP) network administered by a service provider. For example, the network may be implemented using wireless protocols and technologies, such as Wi-Fi, WiMax, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

Example management node 106 may manage different objects/resources in data center 102A to 102N. For example, management node 106 may execute centralized management services that may be interconnected to manage the resources centrally in the virtualized cloud computing infrastructure. Example centralized management service may be a part of vCenter Server™ and vSphere® program products, which are commercially available from Vmware. In an example, a resource may be a server resource, a storage resource, a network resource, a virtual resource, or the like in data center 102A to 102N. For example, the resource may include components in data centers 102A to 102N such as host computing systems 104A to 104N, workloads WL1 to WLN (e.g., virtual machines (VMs), containers, and the like), and the like. In some examples, data center 102A to 102N may be managed by one or more administrators via management node 106.

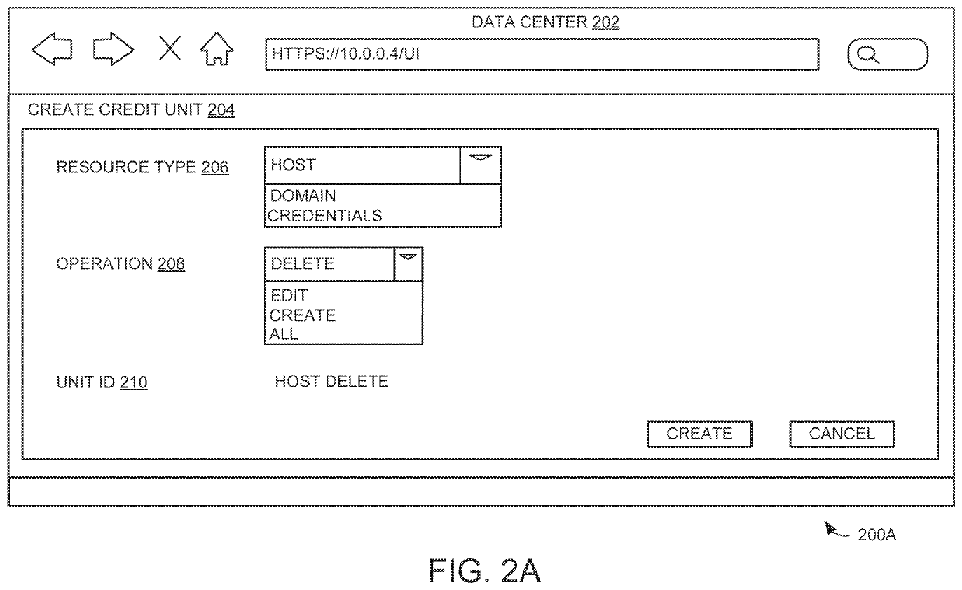

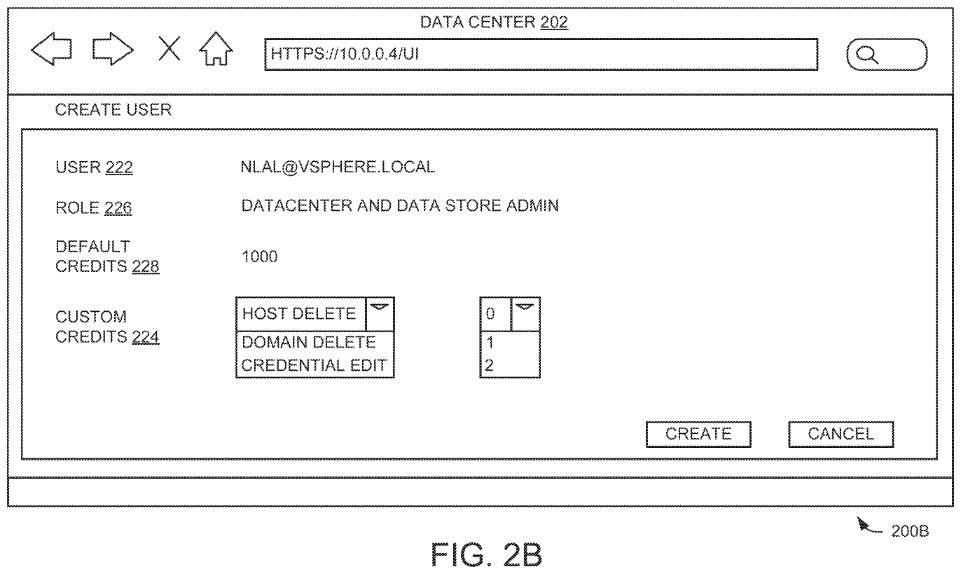

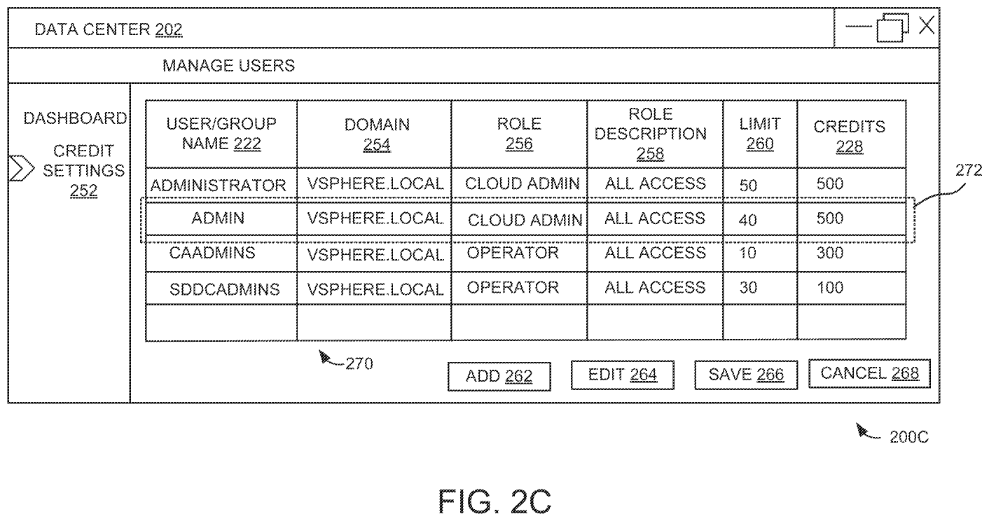

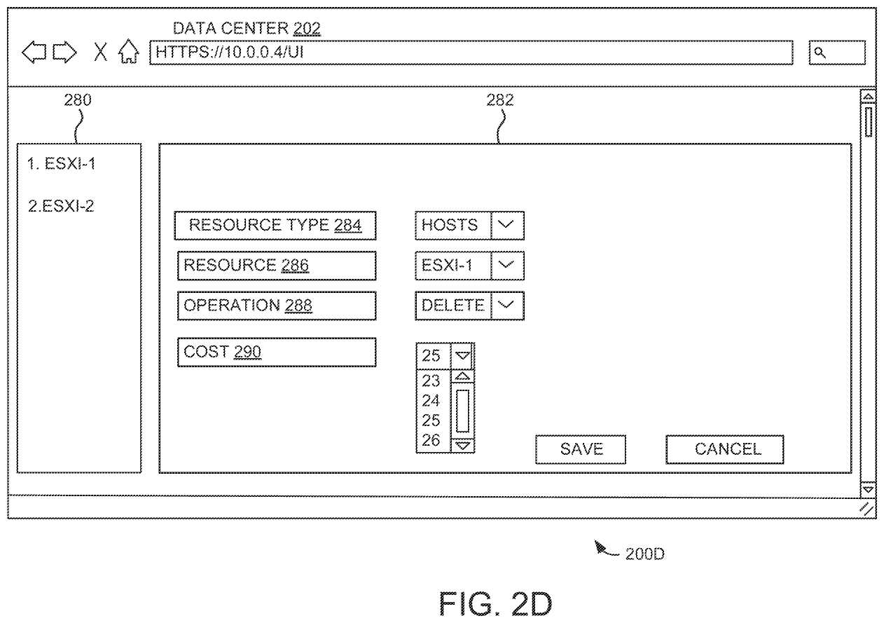

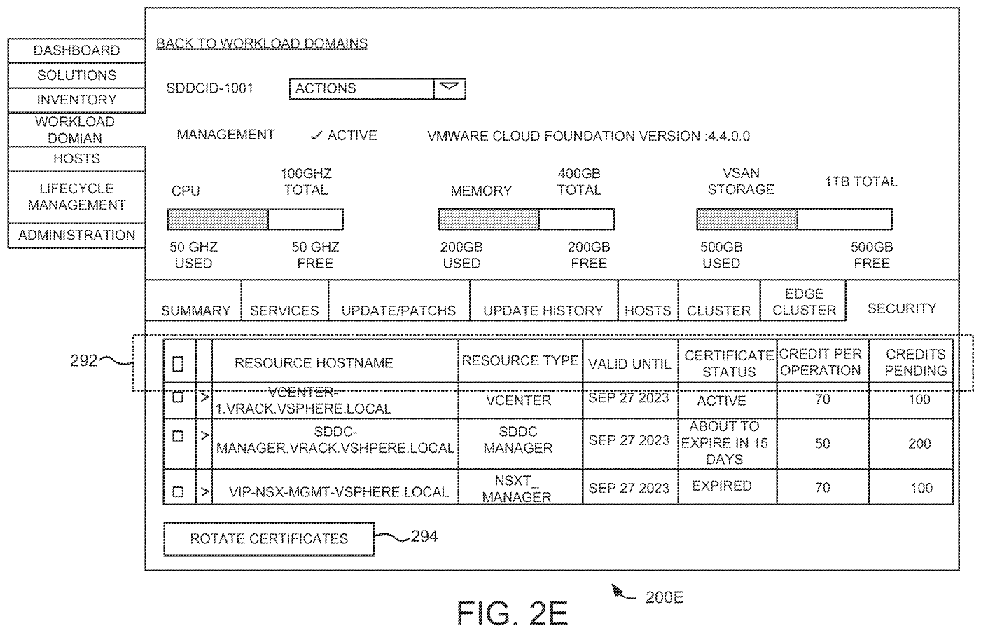

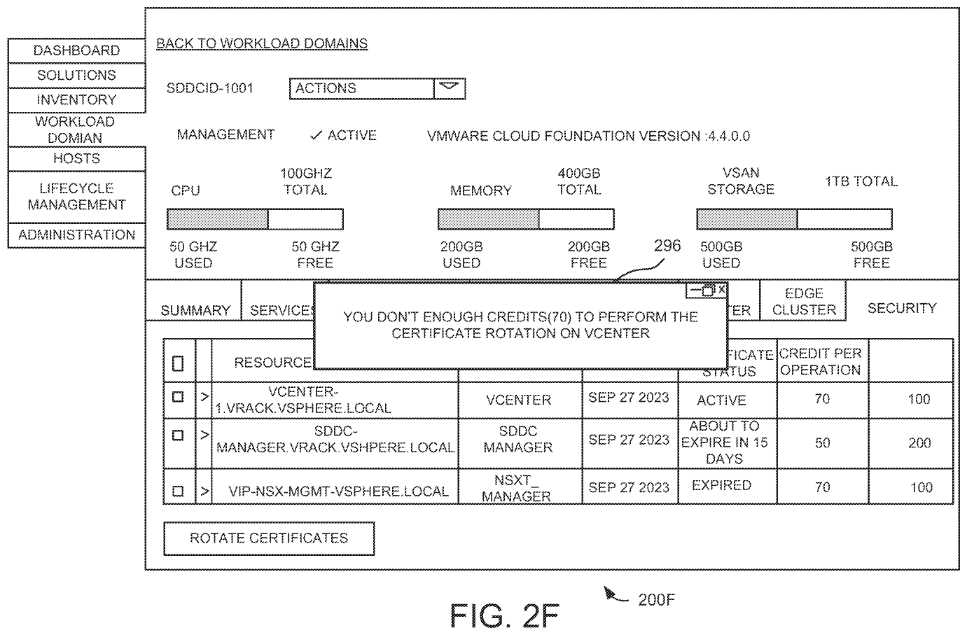

As shown in FIG. 1, management node 106 may include a processor 108 and a memory 110 including a credits-based access controller 112. In an example, credits-based access controller 112 may assign credits to a user account. In some examples, credits-based access controller 112 may set an expiry time for the assigned credits. In this example, the assigned credits may be lapsed upon an expiration of the expiry time. Further, credits-based access controller 112 may set a credit limit corresponding to the user account. The credit limit may indicate maximum credits that can be used to perform each operation in data center 102A to 102N. Furthermore, credits-based access controller 112 may assign a credit unit to the user account. The credit unit may include a value indicating a number of times an operation can be performed on a resource type. A “resource type” may refer to a grouping of one or more resources by type. Hence, resources associated with a particular type of platform, network, domain, device, application, or service may be classified as belonging to a particular resource type. For example, resources associated with a particular resource type may include host units, domain units, restore units, credential units, and the like. Example graphical user interfaces used to assign the credits, the credit limit, and the credit unit are depicted in FIGS. 2A to 2C.

Further, credits-based access controller 112 may associate an attribute to the data center resource. In an example, the attribute may include a value indicating a number of credits to perform each type of operation on the data center resource. An example graphical user interface used to associate the attribute to the data center resource is depicted in FIGS. 2D. As shown in FIG. 1, computing environment 100 may include a repository 114 to store the assigned credits, available credits, the credit limit, and the credit unit associated with the user account. Further, repository 114 may store the attribute associated with the data center resource. In an example, repository 114 may reside external to management node 106 and accessible to management node 106 (e.g., as shown in FIG. 1). In another example, repository 114 may reside within management node 106. Example repository 114 may be a database either embedded within vCenter or external to vCenter, a flat file, or the like.

During operation, credits-based access controller 112 may receive a request to perform an operation on a data center resource from a user associated with the user account. Further, credits-based access controller 112 may determine whether the user is permitted to perform the requested operation on the data center resource based on available credits of the assigned credits, the credit limit, and the credit unit. In an example, credits-based access controller 112 may retrieve an operation value corresponding to the requested operation from an attribute associated with the data center resource. The operation value may indicate a number of credits to perform the requested operation. Further, credits-based access controller 112 may determine whether the user is permitted to perform the requested operation on the data center resource based on the operation value, the available credits, the credit limit, and the credit unit.

Furthermore, credits-based access controller 112 may execute or deny execution of the requested operation on the data center resource based on the determination. In an example, credits-based access controller 112 may deny the execution of the requested operation on the data center resource in response to a determination that the available credits are less than the operation value, the credit limit is less than the operation value, the value indicating the number of times the operation can be performed on the resource type is zero, the number of times the operation has been performed on the resource type exceeds the defined value, or any combination thereof.

In another example, credits-based access controller 112 may permit the execution of the requested operation on the data center resource in response to a determination that the available credits are equal to or greater than the operation value, the credit limit is equal to or greater than the operation value, the value indicating the number of times the operation can be performed on the resource type is greater than or equal to one, and the number of times the operation has been performed on the resource type does not exceed the defined value.

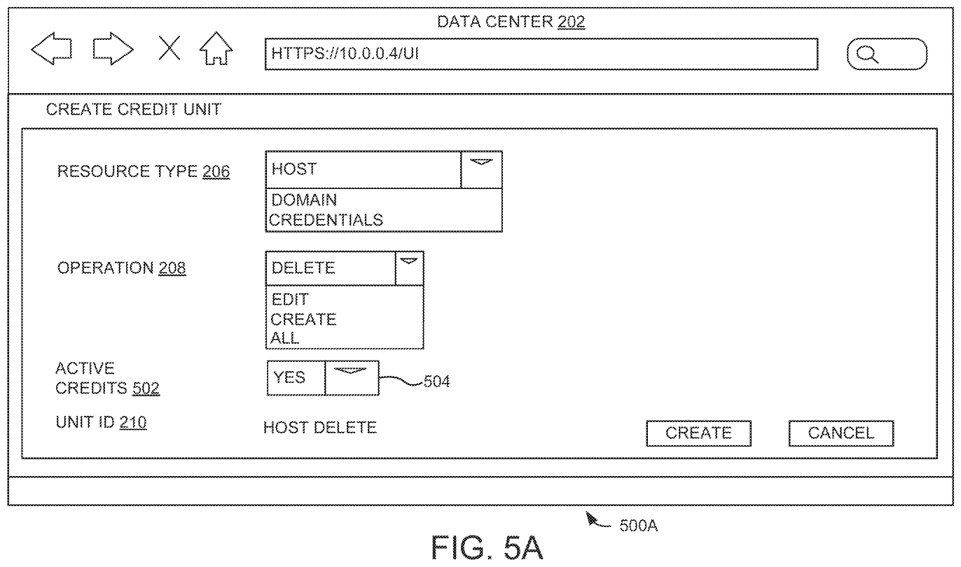

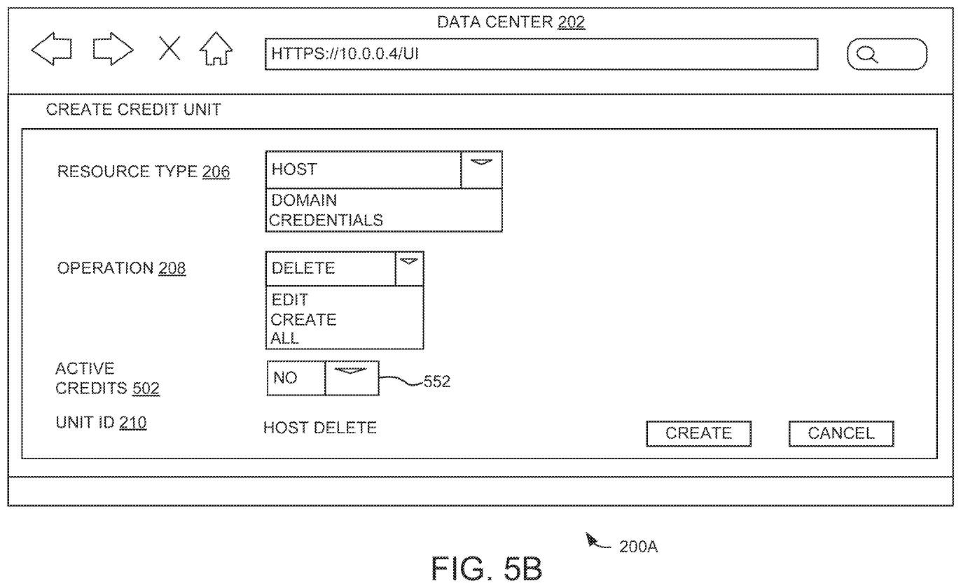

In an example, the user account may be associated with an active credit or a passive credit. For example, when the user account is associated with the active credit, credits-based access controller 112 may deduct a number of credits corresponding to the operation value from the available credits associated with the user account upon either executing the requested operation on the data center resource or denying the execution of the requested operation on the data center resource. Thus, the number of credits corresponding to the operation value can be deducted from the available credits irrespective of whether the requested operation is successful or failed. In another example, when the user account is associated with the passive credit, credits-based access controller 112 may deduct a number of credits corresponding to the operation value from the available credits associated with the user account only upon successful execution of the requested operation on the data center resource. Example graphical user interfaces depicting the user account associated with the active credit or the passive credit are described in FIGS. 5A and 5B.

Further, memory 110 may include a notification unit 116 to send a notification to the user upon denying the request to perform the operation. An example notification may indicate a reason (e.g., less credits, less credit limit, less value associated with the credit unit) for denying the request. Furthermore, memory 110 may include an audit controller 118 to maintain an audit trail to record the information corresponding to actions of the user to access the data center resource, a way in which the credits associated with the user is utilized, and the like. Further, the credits-based access controller 112 may reassign the credits to the user account upon receiving a request for a credit from the user or at regular intervals of time.

In some examples, the administrator may set certain operations such as “restore software defined data center (SDDC)” as “credits exhausting operations”. In this example, when a user performs a credit exhausting operation (e.g., considering that the user has enough credit limit to execute such operation and the value associated with the credit unit is equal to or greater than one), the available credits of the user may be exhausted. Further, exhausting the available credits may prevent the user from performing such operations (e.g., restoration of the SDDC) more than once as restoring is a critical operation. Further, notification unit 116 may notify the administrator to indicate the execution of the restoration operation by the user.

In some examples, the functionalities described in FIG. 1, in relation to instructions to implement functions of credit-based access controller 112, notification unit 116, audit controller 118, and any additional instructions described herein in relation to the storage medium, may be implemented as engines or modules including any combination of hardware and programming to implement the functionalities of the modules or engines described herein. The functions of credit-based access controller 112, notification unit 116, and audit controller 118 may also be implemented by a respective processor. In examples described herein, the processor may include, for example, one processor or multiple processors included in a single device or distributed across multiple devices.

FIG. 2A is an example graphical user interface 200A depicting generation of a credit unit 204. Example graphical user interface 200A may correspond to a data center 202 providing an option to generate credit unit 204. An example credit unit may be a software construct that is made of a resource type 206 (e.g., host, workload domain, credential, and the like) and an operation 208 (e.g., delete, edit, add, and the like), and also carries a value (which is depicted in FIG. 2B). For example, a set of critical operations on resource type 206 may be “host delete”. “credential edit”, “domain delete”, and the like. In an example, credit unit 204 may be at resource type level such as “host units”, “domain units”, “restore units, “credential units”, and the like. Further, a unit identifier 210 may be assigned to credit unit 204. Unit identifier 210 may be unique and may be dynamically generated based on resource type 206 and operation 208 chosen. Further, the generated credit unit can be assessed like a Restful resource and can be assigned to users as described in FIG. 2B.

FIG. 2B is an example graphical user interface 200B depicting assignment of credit units to a user account (e.g., 222). As shown in FIG. 2B, the generated credit unit (e.g., as described in FIG. 2A) is assigned to user account 222. Further, while assigning the credit unit, a value 224 (e.g., a custom credit) may be associated with user account 222 corresponding to the credit unit. The value may be directly proportional to the number of times a user can execute certain operations on the resource type. For example, the value may be set to indicate an operation “host delete” may be performed two times, an operation “domain delete” may not be performed (e.g., by setting the value as zero), and the like. Furthermore, graphical user interface 200B depicts a role 226 of the user and credits 228 associated with the user.

During operation, a credits-based access controller (e.g., credits-based access controller 112 of FIG. 1) may inject the user with the required credits into the security context and intercept application programming interface (API) calls for the authorization based on the credits. For example, when a user is created, the fine-grained credits associated with the user may be injected into a security context. When the user makes a subsequent API call, an identity provider may check if the user is authenticated. When the user is authenticated, a token may be issued which has the credits associated with the user. Further, an interceptor may decode the token and checks whether the user has sufficient credits/privileges for performing the API call. In some examples, when the user does not have sufficient credits, then “401 unauthorized” may be sent to the user and the user is restricted from performing the operation. Furthermore, the credit units (i.e., custom credits 224) may provide significant control at resource type and the operation on the resource type level. For example, access to critical data center resources may be restricted to a number of operations. Hence, examples described herein may provide a finer control at resource type and specific operations on the resource type level.

FIG. 2C is an example graphical user interface 200C depicting assignment of credits 228 and a credit limit 260 to a user account (e.g., 222). Example graphical user interface 200C may correspond to data center 202 providing a credit setting option 252. Using credit setting option 252, an administrator or authorized person of an organization may set credits 228 and credit limit 260 to a user or a group of users 222. As shown in FIG. 2C, a table 270 may depict username 222, a corresponding domain 254 (e.g., a resource type), a role 256 assigned to the user, role description 258, credit limit 260, and credits 228. In an example, the user may perform any operation on data center resources based on available credits in user's account, credit limit 260 as set by the administrator, and associated role 256.

For example, table 270 may depict that a user “admin” is provided with credits “500” and credit limit “40” as shown in 272. Thus, “admin” may perform any operation on the data center resources which costs less than or equal to “40” credits provided that the admin has sufficient custom credits (e.g., 224 as shown in FIG. 2B). Further, the administrator may modify table 270 by adding new user using an add option 262, modifying details using an edit option 264, and the like. Furthermore, graphical user interface 200C may provide options such as save 266 to save the changes, cancel 268 to discard the changes, and the like to maintain table 270.

FIG. 2D is an example graphical user interface 200D depicting associating the value to each type of operation on the data center resource. Example graphical user interface 200D may provide a first portion 280 to display available data center resources (e.g., enterprise-class, type-1 hypervisor (ESXI) 1 and ESXI 2) in data center 202. Further, graphical user interface 200D may display a second portion 282 including multiple options to select data center resources and assign values to various operations on the data center resources. In the example shown in FIG. 2D,
a resource type option 284 may allow an administrator to select a resource type, e.g., “hosts”.
a resource option 286 may allow the administrator to select a resource, e.g., “ESXI-1”.
an operation option 288 may allow the administrator to select an operation (e.g., “delete”) corresponding to the data center resource “ESXI-1”.
a cost option 290 may allow the administrator to assign value to the selected operation (e.g., “delete”).

Further, a user may select one of the data center resource (e.g., ESXI-1) in first portion 280. Upon selecting the data center resource, a second portion 282 may be displayed, where the operations (e.g., delete, rotate, and the like) and corresponding values (i.e., a number of credits) may be displayed. As shown in FIG. 2D, second portion 282 includes a resource type 284, resource 286, an operation 288, and corresponding cost 290. Thus, the user can visualize the data center resource configuration from one place. Further, the administrator can assign values for various operations (e.g., add, delete, edit, and the like) associated with various data center resources. Further, the administrator may save the assignment of values using a save option, discard any changes to the values using a cancel option, and the like.

FIG. 2E is an example graphical user interface 200E depicting execution of an operation (e.g., 294) on the data center resource. Example graphical user interface 200E includes a table depicting a resource hostname, a resource type, validity, a certificate status, credit per operation, and pending credits (e.g., as shown in 292). In this example, the user may perform the operation (e.g., “rotate certificates” 294). Upon selecting “rotate certificates” 294, the operation may be executed.

FIG. 2F is an example graphical user interface 200F depicting a notification (e.g., 296) indicating status of the execution of the operation on the data center resource. When “rotate certificates” 294 of FIG. 2E operation is not able to execute, notification 296 may be displayed on graphical user interface 200F. Example notification 296 may indicate a reason for not executing the operation. An example reason may include insufficient credits to perform the operation, the credit limit less than the cost of operation, insufficient custom credits, and the like.

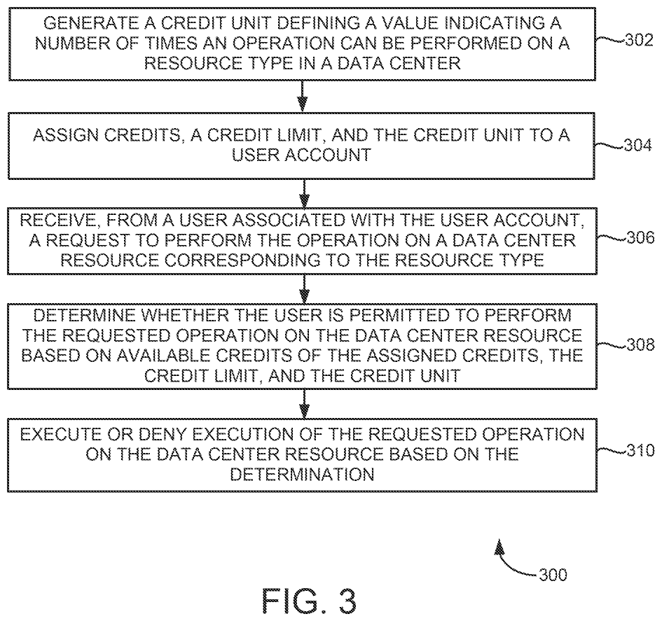

FIG. 3 is a flowchart illustrating an example method 300 for controlling an access to perform a requested operation on a data center resource. At 302, a credit unit defining a value indicating a number of times an operation can be performed on a resource type in a data center may be generated. In an example, generating the credit unit may include generating the credit unit by associating the operation and the resource type in the data center and defining the value corresponding to the credit unit.

At 304, credits, a credit limit, and the credit unit may be assigned to a user account. The credit limit may indicate maximum credits that can be used to perform each operation in the data center. In an example, assigning the credits, the credit limit, and the credit unit to the user account may include:
assigning at least one of a role-based access control and a scope-based access control to the user account, and
assigning the credits, the credit limit per operation, and the credit unit to the user account upon assigning at least one of the role-based access control and the scope-based access control.

For example, an administrator may assign or grant “300” credits to the user for regular operations. Further, the administrator may set a credit limit of “20” for the user. Also, an expiry time to utilize the assigned credits associated with the user account may be set. Furthermore, the administrator may assign a value corresponding to the credit unit as “2” so that the user may be able to execute an operation corresponding to the credit unit only twice. Thus, the user may not be able to execute any operation that costs more than “20” credits. Further, the user can perform all the operations within his role or scope permissions except those incur cost more than “20” credits. Also, the user may be restricted to perform the operation on a particular resource type for a limited number of times as specified in the credit unit.

At 306, a request to perform the operation on a data center resource corresponding to the resource type may be received from a user associated with the user account. At 308, a check may be made to determine whether the user is permitted to perform the requested operation on the data center resource based on available credits of the assigned credits, the credit limit, and the credit unit.

In an example, determining whether the user is permitted to perform the requested operation on the data center resource may include retrieving an operation value corresponding to the requested operation from an attribute associated with the data center resource. The operation value may indicate a number of credits to perform the requested operation. In an example, retrieving the operation value corresponding to the requested operation may include retrieving the attribute associated with the data center resource from an attribute repository and retrieving the operation value corresponding to the requested operation from the retrieved attribute. The operation value defined in the attribute may be configurable. Further, a check may be made to determine whether the user is permitted to perform the requested operation on the data center resource based on the operation value, the available credits, the credit limit, and the credit unit.

At 310, the requested operation on the data center resource may be executed or denied based on the determination. In an example, the execution of the requested operation on the data center resource may be denied in response to a determination that the available credits are less than the operation value, the credit limit is less than the operation value, the value indicating the number of times the operation can be performed on the resource type is zero, the number of times the operation has been performed on the resource type exceeds the defined value, or any combination thereof.

For example, consider the available credits are “300”, the credit limit is “20”, the operation value is “30”, and the value corresponding to the credit unit is “0”. In this example, the access to perform the requested operation is restricted as the credit limit (i.e., “20” credits) is less than the operation value (i.e., “30” credits) and also the value corresponding to the credit unit is “0”. In another example, consider the available credits are “20”, the credit limit is “40”, the operation value is “30”, and the value corresponding to the credit unit is “2”. In this example, the access to perform the requested operation is restricted as the available credits (i.e., “20” credits) is less than the retrieved value (i.e., “30” credits).

In another example, the execution of the requested operation on the data center resource may be permitted in response to a determination that the available credits are equal to or greater than the operation value, the credit limit is equal to or greater than the operation value, the value indicating the number of times the operation can be performed on the resource type is greater than or equal to one, and the number of times the operation has been performed on the resource type does not exceed the defined value.

For example, consider the available credits are “300”, the credit limit is “20”, the operation value is “15”, and the value corresponding to the credit unit is “2”. In this example, the access to perform the requested operation is permitted as the credit limit (i.e., “20” credits) is greater than the retrieved value (i.e., “15” credits), the available credits (i.e., “300” credits) is greater than the retrieved value (i.e., “15” credits), and also the value of the credit unit is greater than “0”.

In an example, the user account may be associated with an active credit or a passive credit. For example, when the user account is associated with the active credit, a number of credits corresponding to the operation value may be deducted from the available credits associated with the user account upon either executing the requested operation on the data center resource or denying the execution of the requested operation on the data center resource. In another example, when the user account is associated with the passive credit, a number of credits corresponding to the operation value may be deducted from the available credits associated with the user account upon executing the requested operation on the data center resource.

Example method 300 may include determining that the assigned credits, the credit unit, or both are utilized in accordance with an organization policy. Further, the credits, the credit unit, or both may be reassigned to the user account in response to the determination. In an example, an expiry time may be set to utilize the assigned credits and the credit unit associated with the user account. Further, an audit record of the user's transactions associated with a utilization of the assigned credits and the credit unit periodically or upon the available credits and/or the value fall below a threshold may be obtained. Thus, examples described herein may be implemented either independently of a role-based access control and a scope-based access control. Also, examples described herein may be implemented seamlessly along with the role-based access control and/or the scope-based access control to enhance user experience.

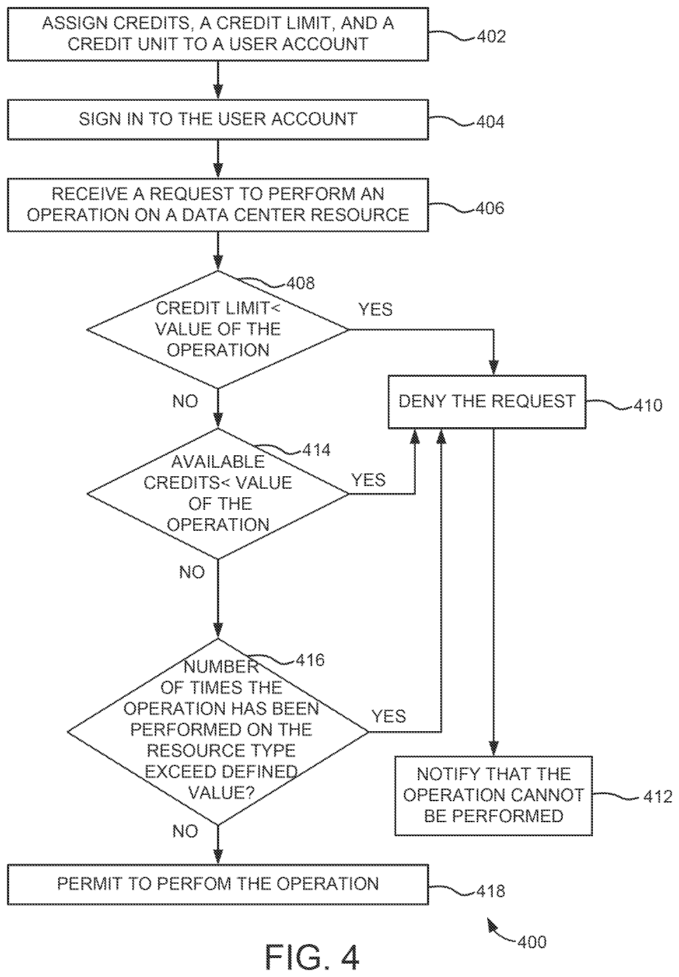

FIG. 4 is a flowchart illustrating another example method 400 for controlling an access to perform a requested operation on a data center resource. At 402, credits, a credit limit, and a credit unit may be assigned to a user account by an administrator or an authorized person of an organization. For example, the administrator may grant “300” credits to the user for user's regular operations. Further, when certain operations (e.g., a password rotate operation) on the data center resource may have to be prevented, the administrator may set a credit limit of “20” for the user and assign a value (e.g., “25” credits) greater than “20” for password rotate operation (e.g., in management Vcenter). Furthermore, a value corresponding to the credit unit may be set as “3” to indicate a number of times (i.e., “3”) an operation can be performed on a resource type (e.g., 3 times the user can perform host delete operation). Thus, by setting the credits, the credit limit, and the credit unit, the administrator can prevent any changes to critical data center resources from the users.

At 404, the user may sign-in to the user account. For example, the user may sign-in to the account using corresponding username and unique password. At 406, the user may request to perform an operation on a data center resource.

At 408, a check may be made to determine whether the credit limit associated with the user is less than a value associated with the operation. When the credit limit is less than the value, the request may be denied, at 410. Further, a notification may be sent to the user that the operation may not be performed as the credit limit is less corresponding to the operation, at 412. In this example, the user may request the administrator to increase the credit limit to perform the operation. Further, the administrator may analyze whether the user can perform the operation and act on the request.

When the credit limit is equal to or greater than the value, a check may be made to determine whether available credits associated with the user is less than the value associated with the operation, at 414. When the available credit is less than the value, the request may be denied, at 410. Further, a notification may be sent to the user that the operation may not be performed as the credits are less corresponding to the operation, 412. In this example, the user may request the administrator for additional credits to perform the operation. Further, the administrator may analyze whether the user can perform the operation and act on the request.

When the available credits are equal to or greater than the value, a check may be made to determine whether a number of times the operation has been performed on the resource type exceeds a defined value in the assigned credit unit, at 416. When the number of times the operation has been performed on the resource type exceeds the defined value, the request may be denied, at 410. Further, a notification may be sent to the user that the operation may not be performed as the user has exceeded the number of times the operation can be performed on the resource type, 412. In this example, the user may request the administrator for modifying the defined value in the credit unit.

When the number of times the operation has been performed on the resource type does not exceeds the defined value, the user may be permitted to perform the operation, at 418. Further, the administrator may monitor the actions of the user by obtaining an audit of the user transactions through credits history which will be useful while reassigning the credits, modifying the value in the credit unit, and the like to the user. Thus, examples described herein may provide the administrator with operational level access control on the data center resources. Further, when examples described herein is used in conjunction with a role-based access control and a scope-based access control, a need of creating a new custom roles and scopes may be eliminated.

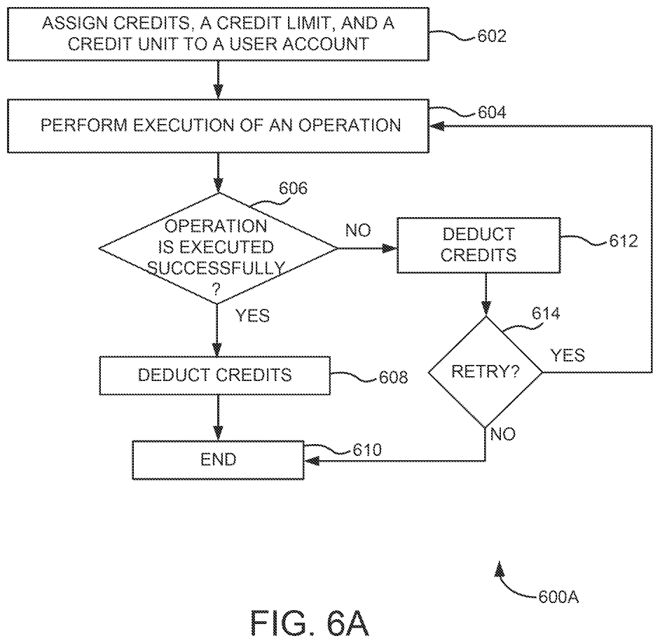

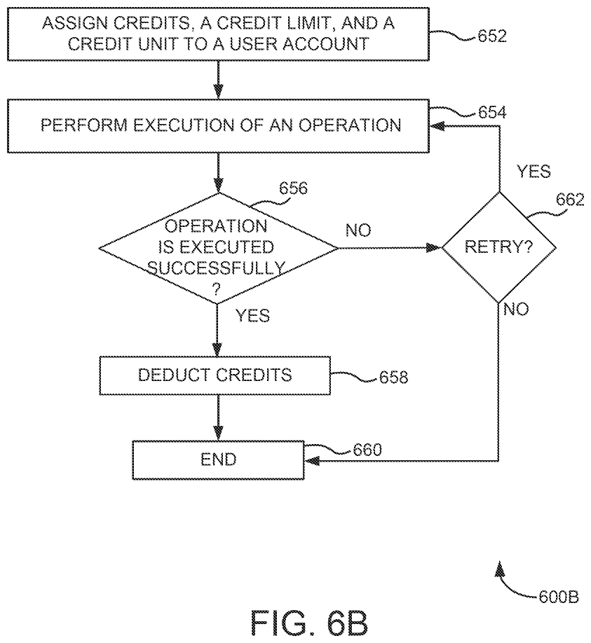

Further, a number of credits corresponding to the operation value may be deducted from the available credits associated with the user account upon either executing the requested operation on the data center resource or denying the execution of the requested operation on the data center resource based on a type of the credits (e.g., active credits or passive credits), which is described in FIGS. 5A, 5B, 6A, and 6B.

It should be understood that the process depicted in FIGS. 3 and 4 represent generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate computer-readable instructions, or use a combination of hardware and computer-readable instructions to perform the illustrated processes.

FIG. 5A is an example graphical user interface 500A, depicting associating active credits corresponding to a user account. Example graphical user interface 500A may correspond to a data center 202 providing an option to define a type of credits to a user account. As shown in FIG. 5A, for performing operation 208 on resource type 206, the type of credits 502 may be defined. For example, for performing “delete” operation on the resource type “host”, the credits are defined as “active” (e.g., 504). During operation, when the credits are defined as “active”, the credits are deducted from the user account when the execution of the operation is a failure or a success. Thus, the active credits may be significantly restrictive on the user, and it also ensures the user cannot keep retrying an operation without making any remedy for the failure reason as multiple retries without taking necessary action may put the system into an inconsistent state.

FIG. 5B is an example graphical user interface 500B depicting associating passive credits corresponding to a user account. As shown in FIG. 5B, performing “delete” operation on the resource type “host”, the credits are defined as “passive” (e.g., 552). During operation, when the credits are defined as “passive”, the credits may be deducted from the user account when the operations are successful. Further, an administrator may choose which user to grant active and passive credits as depicted in FIGS. 5A and 5B.

FIG. 6A is a flowchart illustrating an example method 600A for deducting credits when the credits are defined as active credits. At 602, a user account may be assigned with credits, a credit limit, and a credit unit. At 604, a user associated with the user account may perform execution of an operation based on available credits of the assigned credits, the credit limit, and the credit unit.

At 606, a check may be made to determine whether the operation is successfully executed. When the operation is successfully executed, a number of credits corresponding to the operation value may be deducted from the available credits associated with the user account, at 608 and the process may be terminated, at 610. When the operation is not successfully executed, the number of credits corresponding to the operation value may be deducted from the available credits associated with the user account, at 612. Further, at 614, a check may be made to determine whether the user has attempted to retry executing the operation. When the user has attempted to retry, the operation may be executed, at 604. When the user does not attempt to retry, the process may be terminated, at 610.

Thus, when the user account is associated with the active credit, the number of credits corresponding to the operation value may be deducted from the available credits associated with the user account upon either executing the requested operation on the data center resource or denying the execution of the requested operation on the data center resource.

FIG. 6B is a flowchart illustrating an example method 600B for deducting credits when the credits are defined as passive credits. At 652, a user account may be assigned with credits, a credit limit, and a credit unit. At 654, a user associated with the user account may perform execution of an operation based on available credits of the assigned credits, the credit limit, and the credit unit.

At 656, a check may be made to determine whether the operation is successfully executed. When the operation is successfully executed, a number of credits corresponding to the operation value may be deducted from the available credits associated with the user account, at 658 and the process may be terminated, at 660. When the operation is not successfully executed, a check may be made to determine whether the user has attempted to retry executing the operation, at 662. When the user has attempted to retry, the operation may be executed, at 654. When the user does not attempt to retry, the process may be terminated, at 660.

Thus, when the user account is associated with the passive credit, a number of credits corresponding to the operation value may be deducted from the available credits associated with the user account upon executing the requested operation on the data center resource.

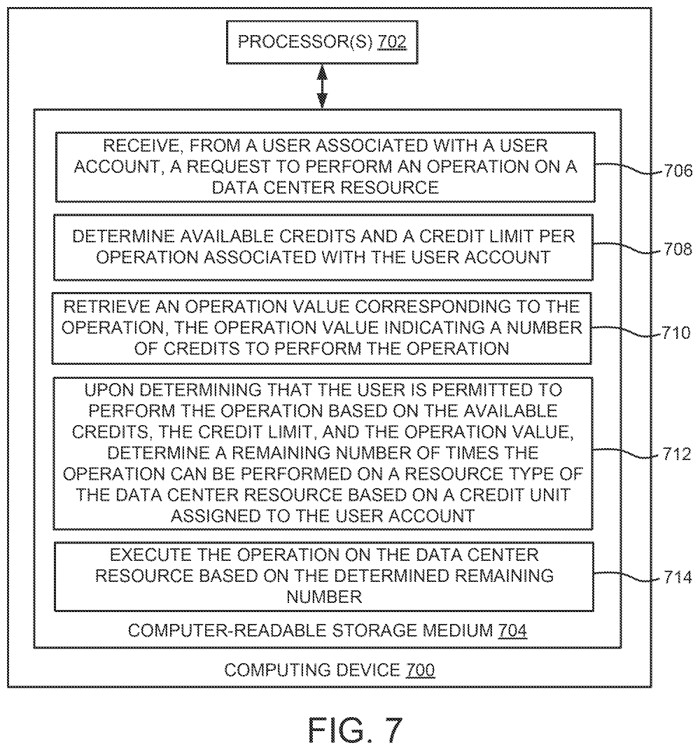

FIG. 7 is a block diagram of an example computing device 700 including non-transitory computer-readable storage medium 704 storing instructions to execute a requested operation on a data center resource. Computing device 700 (e.g., management node 106 of FIG. 1) may include a processor 702 and computer-readable storage medium 704 communicatively coupled through a system bus. Processor 702 may be any type of central processing unit (CPU), microprocessor, or processing logic that interprets and executes computer-readable instructions stored in computer-readable storage medium 704.

Computer-readable storage medium 704 may be a random-access memory (RAM) or another type of dynamic storage device that may store information and computer-readable instructions that may be executed by processor 702. For example, computer-readable storage medium 704 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 704 may be a non-transitory computer-readable medium. In an example, computer-readable storage medium 704 may be remote but accessible to computing device 700.

Computer-readable storage medium 704 may store instructions 706-714. In an example, instructions 706-714 may be executed by processor 702 to permit performing a requested operation on a data center resource. Instructions 706 may be executed by processor 702 to receive a request to perform an operation on a data center resource from a user associated with a user account.

Instructions 708 may be executed by processor 702 to determine available credits and a credit limit per operation associated with the user account upon receiving the request. Instructions 710 may be executed by processor 702 to retrieve an operation value corresponding to the operation. In an example, the operation value may indicate a number of credits to perform the operation.

Further, upon determining that the user is permitted to perform the operation based on the available credits, the credit limit, and the operation value, instructions 712 may be executed by processor 702 to determine a remaining number of times the operation can be performed on a resource type of the data center resource based on a credit unit assigned to the user account.

Instructions 714 may be executed by processor 702 to execute the operation on the data center resource based on the determined remaining number. In an example, instructions 714 to execute the requested operation on the data center resource may include instructions to permit execution of the requested operation on the data center resource in response to a determination that the remaining number of times the operation can be performed on the resource type is greater than or equal to a threshold. In another example, computer-readable storage medium 704 may store instructions to deny executing the operation on the data center resource in response to a determination that the remaining number of times the operation can be performed on the resource type is less than a threshold.

Some or all of the system components and/or data structures may also be stored as contents (e.g., as executable or other computer-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,”“have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A computer implemented method comprising:
generating a credit unit defining a value indicating a number of times an operation can be performed on a resource type in a data center;
assigning credits, a credit limit, and the credit unit to a user account, wherein the credit limit is to indicate maximum credits that can be used to perform each operation in the data center;
receiving, from a user associated with the user account, a request to perform the operation on a data center resource corresponding to the resource type;
determining whether the user is permitted to perform the requested operation on the data center resource based on available credits of the assigned credits, the credit limit, and the credit unit; and
executing or denying execution of the requested operation on the data center resource based on the determination.

2. The computer implemented method of claim 1, wherein generating the credit unit comprises:
generating the credit unit by associating the operation and the resource type in the data center; and
defining the value corresponding to the credit unit.

3. The computer implemented method of claim 1, wherein determining whether the user is permitted to perform the requested operation on the data center resource comprises:
retrieving an operation value corresponding to the requested operation from an attribute associated with the data center resource, wherein the operation value is to indicate a number of credits to perform the requested operation; and
determining whether the user is permitted to perform the requested operation on the data center resource based on the operation value, the available credits, the credit limit, and the credit unit.

4. The computer implemented method of claim 3, wherein executing or denying the execution of the requested operation comprises:
denying the execution of the requested operation on the data center resource in response to a determination that:
the available credits are less than the operation value;
the credit limit is less than the operation value;
the value indicating the number of times the operation can be performed on the resource type is zero;
the number of times the operation has been performed on the resource type exceeds the defined value; or
any combination thereof.

5. The computer implemented method of claim 3, wherein executing or denying the execution of the requested operation comprises:
permitting the execution of the requested operation on the data center resource in response to a determination that:
the available credits are equal to or greater than the operation value:
the credit limit is equal to or greater than the operation value;
the value indicating the number of times the operation can be performed on the resource type is greater than or equal to one; and
the number of times the operation has been performed on the resource type does not exceed the defined value.

6. The computer implemented method of claim 3, further comprising:
when the user account is associated with an active credit, deducting a number of credits corresponding to the operation value from the available credits associated with the user account upon either executing the requested operation on the data center resource or denying the execution of the requested operation on the data center resource.

7. The computer implemented method of claim 3, further comprising:
when the user account is associated with a passive credit, deducting a number of credits corresponding to the operation value from the available credits associated with the user account upon executing the requested operation on the data center resource.

8. The computer implemented method of claim 3, wherein retrieving the operation value corresponding to the requested operation comprises:
retrieving the attribute associated with the data center resource from an attribute repository; and
retrieving the operation value corresponding to the requested operation from the retrieved attribute, wherein the operation value defined in the attribute is configurable.

9. The computer implemented method of claim 1, wherein assigning the credits, the credit limit, and the credit unit to the user account comprises:
assigning at least one of a role-based access control and a scope-based access control to the user account; and
assigning the credits, the credit limit per operation, and the credit unit to the user account upon assigning at least one of the role-based access control and the scope-based access control.

10. The computer implemented method of claim 1, further comprising:
determining that the assigned credits, the credit unit, or both are utilized in accordance with an organization policy; and
reassigning the credits, the credit unit, or both to the user account in response to the determination.

11. The computer implemented method of claim 1, further comprising:
setting an expiry time to utilize the assigned credits and the credit unit associated with the user account; and
obtaining an audit record of the user's transactions associated with a utilization of the assigned credits and the credit unit periodically or upon the available credits and/or the value fall below a threshold.

12. A management node comprising:
a processor; and
a memory comprising a credits-based access controller to:
assign credits to a user account;
set a credit limit corresponding to the user account, wherein the credit limit is to indicate maximum credits that can be used to perform each operation in a data center;
assign a credit unit to the user account, wherein the credit unit includes a value indicating a number of times an operation can be performed on a resource type;
receive, from a user associated with the user account, a request to perform an operation on a data center resource;
determine whether the user is permitted to perform the requested operation on the data center resource based on available credits of the assigned credits, the credit limit, and the credit unit; and
execute or deny execution of the requested operation on the data center resource based on the determination.

13. The management node of claim 12, wherein the credits-based access controller is to:
retrieve an operation value corresponding to the requested operation from an attribute associated with the data center resource, wherein the operation value is to indicate a number of credits to perform the requested operation; and
determine whether the user is permitted to perform the requested operation on the data center resource based on the operation value, the available credits, the credit limit, and the credit unit.

14. The management node of claim 13, wherein the credits-based access controller is to:
deny the execution of the requested operation on the data center resource in response to a determination that:
the available credits are less than the operation value;
the credit limit is less than the operation value;
the value indicating the number of times the operation can be performed on the resource type is zero;
the number of times the operation has been performed on the resource type exceeds the defined value; or
any combination thereof.

15. The management node of claim 13, wherein the credits-based access controller is to:
permit the execution of the requested operation on the data center resource in response to a determination that:
the available credits are equal to or greater than the operation value:
the credit limit is equal to or greater than the operation value;
the value indicating the number of times the operation can be performed on the resource type is greater than or equal to one; and
the number of times the operation has been performed on the resource type does not exceed the defined value.

16. The management node of claim 13, wherein the credits-based access controller is to:
when the user account is associated with an active credit, deduct a number of credits corresponding to the operation value from the available credits associated with the user account upon either executing the requested operation on the data center resource or denying the execution of the requested operation on the data center resource.

17. The management node of claim 13, wherein the credits-based access controller is to:
when the user account is associated with a passive credit, deduct a number of credits corresponding to the operation value from the available credits associated with the user account upon executing the requested operation on the data center resource.

18. A non-transitory computer-readable storage medium encoded with instructions that, when executed by a processor of a computing device, cause the processor to:
receive, from a user associated with a user account, a request to perform an operation on a data center resource;
upon receiving the request, determine available credits and a credit limit per operation associated with the user account;
retrieve an operation value corresponding to the operation, the operation value indicating a number of credits to perform the operation;
upon determining that the user is permitted to perform the operation based on the available credits, the credit limit, and the operation value, determine a remaining number of times the operation can be performed on a resource type of the data center resource based on a credit unit assigned to the user account; and
execute the operation on the data center resource based on the determined remaining number.

19. The non-transitory computer-readable storage medium of claim 18, further comprising instructions that, when executed by the processor, cause the processor to:
deny executing the operation on the data center resource in response to a determination that the remaining number of times the operation can be performed on the resource type is less than a threshold.

20. The non-transitory computer-readable storage medium of claim 18, wherein instructions to execute the requested operation on the data center resource instructions to:
permit execution of the requested operation on the data center resource in response to a determination that the remaining number of times the operation can be performed on the resource type is greater than or equal to a threshold.
